(19) United States
(12) Patent Application Publication
(10) Pub. No.: US 2010/0240814 A1
(43) Pub. Date: Sep. 23, 2010

(54) Flame-Retardant Polyester Resin Composition Having Excellent Heat Resistance

(75) Inventors: Seong Ho KONG, Uiwang-si (KR); Kyung Hoon SHIN, Uiwang-si (KR); Jin Seong LEE, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/792,235

(22) Filed: Jun. 2, 2010

Related U.S. Application Data
(63) Continuation-in-part of application No. PCT/KR2008/007112, filed on Dec. 2, 2008.

(30) Foreign Application Priority Data
Dec. 24, 2007 (KR) 10-2007-0136179

(51) Int. Cl. C08K 5/5313; C08K 3/04; C08K 3/40; C08K 3/00

(52) U.S. Cl. 524/133

(57) ABSTRACT

Disclosed herein is a flame retardant polyester resin composition that can have excellent heat resistance comprising (A) about 100 parts by weight of a polyester resin; (B) about 1 to about 50 parts by weight of a metal salt of an organic phosphinic acid; (C) about 0.01 to about 20 parts by weight of an ionomer resin; and (D) about 1 to about 100 parts by weight of a filler. The resin composition of the present invention composition can have excellent heat resistance while maintaining mechanical properties, and also does not produce toxic halide gases.

### CROSS-REFERENCE TO RELATED APPLICATIONS

This application is a continuation-in-part of International Application No. PCT/KR2008/007112, filed Dec. 2, 2008, pending, which designates the U.S., published as WO 2009/082096, and is incorporated herein by reference in its entirety, and claims priority therefrom under 35 USC Section 120. This application also claims priority under 35 USC Section 119 from Korean Patent Application No. 10-2007-0136179, filed Dec. 24, 2007, in the Korean Intellectual Property Office, the entire disclosure of which is also incorporated herein by reference.

### FIELD OF THE INVENTION

The present invention relates to a flame-retardant polyester resin composition that can have excellent heat resistance.

### BACKGROUND OF THE INVENTION

Polyester resin generally has excellent chemical resistance, mechanical properties and heat resistance so that the resin has been widely used for housings of electric and electronic goods and connectors. When a polyester resin is used for electric and electronic goods, one method for imparting flame retardancy is to add a halogen-containing compound and an antimony-containing compound to the polyester resin. Adding a halogen-containing compound and antimony-containing compound to a polyester resin can provide flame retardancy without deteriorating physical properties.

However, it has been reported that hydrogenated halide gases produced during molding processes can be very toxic and harmful and can erode molding machines and equipment. Furthermore, toxic gases such as dioxins produced during combustion may cause environmental pollution in addition to being harmful to human health. Therefore, many countries regulate the use of halogen-containing flame retardants and there is increasing demand for a method for imparting flame retardancy which does not use a halogen-containing flame retardant.

Because polyester resin generally has low crystallization speed during the molding process as compared to other polymeric materials, there is a drawback in that its moldability and physical properties may be deteriorated when used alone. In order to solve this problem, a small amount of a nucleating agent has been added to the polyester resin to improve crystallization speed.

An ionomer is a resin including a small amount of ionic groups in a nonpolar polymeric chain. The ionic groups are formed by neutralizing a small amount (15% or less) of carboxylic groups or sulfonic groups included in the backbone. The attractive force between the introduced ions of the ionomer can change morphology and the ionomer can exhibit different physical properties as compared to conventional polymers. Thus, ionomer resins have been widely used for adhesives, membranes, filler, imaging systems, impact modifiers, rheology modifiers, compatibilizers, and complex materials for electrochemical properties, among other applications.

### SUMMARY OF THE INVENTION

The present inventors have developed a polyester resin composition that can have excellent flame retardancy and heat resistance. The flame-retardant polyester resin composition of the invention also does not produce toxic halide gases, can maintain mechanical properties of the polyester resin, and can have good dimensional stability. The composition can exhibit these and other benefits as a result of adding a metal salt of an organic phosphinic acid, an ionomer resin, and a filler to a polyester resin.

The flame retardant polyester resin composition of the invention comprises (A) about 100 parts by weight of a polyester resin; (B) about 1 to about 50 parts by weight of a metal salt of an organic phosphinic acid; (C) about 0.01 to about 20 parts by weight of an ionomer resin; and (D) about 1 to about 100 parts by weight of a filler, wherein the amount of (B), (C) and (D) is based on about 100 parts by weight of the polyester resin (A).

The polyester resin (A) may include polyethylene terephthalate, polybutylene terephthalate or a mixture thereof.

The metal salt of an organic phosphinic acid (B) may have an average particle size of about 0.05 to about 10 μm.

The metal salt of an organic phosphinic acid may have a phosphorus content of about 10 to about 70% by weight.

The ionomer resin (C) may include a copolymer of an α-olefin and an α,β-unsaturated carboxylic acid, a sulfonic acid group-substituted polystyrene, a copolymer of an α-olefin, an α,β-unsaturated carboxylic acid, and a copolymerizable monomer, or a mixture thereof which is neutralized with metal ions having a valence of from 1 to 4.

The ionomer resin (C) may have an acid content of about 3 to about 25% by weight.

Examples of the filler (D) may include carbon fiber, glass fiber, glass bead, glass flake, carbon black, clay, kaolin, talc, mica, calcium carbonate, and the like, and mixtures thereof.

In exemplary embodiments, the resin composition may further comprise one or more additives such as heat stabilizers, antioxidants, compatibilizers, light stabilizers, releasing agents, lubricants, pigments, dyes, inorganic fillers, flame retardants, flame retardant aids, nucleating agents, impact modifiers, coupling agents, antistatic agents, dispersants and the like, and mixtures thereof.

The present invention further provides a molded article molded from the resin composition. In an exemplary embodiment, the molded article may have a flame retardancy of 5V at a sample thickness of 2.0 mm according to UL-94 5V Test and a vicat softening temperature of about 220° C. or higher at a sample thickness of ¼″ under a load of 18.5 kg/cm² according to ASTM D648. The resin composition may be molded into housings of electrical and electronic goods.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

(A) Polyester Resin

The polyester resin of the present invention may be used as a base resin. The polyester resin may be a thermoplastic polyester.

In exemplary embodiments, examples of the polyester resin may include without limitation polyalkylene terephthalates such as polyethylene terephthalate, polybutylene terephthalate, and polytrimethylene terephthalate; polyalkylene naphthalates such as polyethylene naphthalate, polypropylene naphthalate, and polybutylene naphthalate; dibenzoates such as polyethylene bibenzoate; copolyesters thereof; and the like; and mixtures thereof.

In an exemplary embodiment, the polyester resin can include polybutylene terephthalate. The polybutylene terephthalate can be prepared as known in the art, for example, by a direct esterification or an ester-exchange reaction of terephthalic acid or dimethyl terephthalate and 1,4-butanediol followed by polycondensation.

In another exemplary embodiment, the polyester resin can include polyethylene terephthalate. The polyethylene terephthalate can also be prepared as known in the art, for example, by a direct esterification or an ester-exchange reaction of terephthalic acid or dimethyl terephthalate and ethylene glycol.

In another exemplary embodiment, in order to increase impact strength of the resin, polybutylene terephthalate may be copolymerized with polytetramethylene glycol, polyethyleneglycol, polypropylene glycol, or low molecular weight aliphatic polyester or aliphatic polyamide, or the polybutylene terephthalate can be modified by blending the polybutylene terephthalate with components for improving the impact strength of the resin.

In exemplary embodiments, the polyester resin (A) may include polyethylene terephthalate, polybutylene terephthalate or a mixture thereof.

The polyester resin or copolymer thereof used in the present invention may have an intrinsic viscosity of about 0.3 to about 1.15 dL/g, for example about 0.5 to about 1.0 dL/g, and as another example about 0.55 to about 0.9 dL/g.

In exemplary embodiments, polyethylene terephthalate having an intrinsic viscosity of about 0.3 to about 1.6 dL/g as measured in a solvent of o-chlorophenol at a temperature of 25° C. may be used.

The polyester resin (A) may not include a plasticizer.

In exemplary embodiments, a polyester resin having a high melting point of about 250° C. or more can be used.

(B) Metal Salt of an Organic Phosphinic Acid

The metal salt of an organic phosphinic acid of the present invention may be a compound represented by the following chemical formula 1 or a combination of compounds of formula 1 with one another.

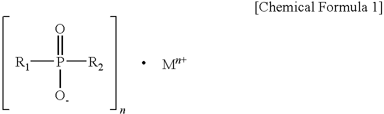

wherein R₁ and R₂ are independently C₁-C₆ alkyl, C₃-C₆ cyclic alkyl or C₆-C₁₀ aryl; M is Al, Zn, Mg, K or Ca; and n is an integer of 1 or 3.

In exemplary embodiments of the invention, R may be methyl, ethyl, propyl, butyl or phenyl, and M may be Al or Zn.

Examples of the metal salt of an organic phosphinic acid may include without limitation an aluminum salt of dimethylphosphinic acid, an aluminum salt of diethylphosphinic acid, an aluminum salt of dipropylphosphinic acid, an aluminum salt of dibutylphosphinic acid, an aluminum salt of diphenylphosphinic acid, a zinc salt of dimethylphosphinic acid, a zinc salt of diethylphosphinic acid, and the like, and mixtures thereof.

In exemplary embodiments of the invention, the metal salt of an organic phosphinic acid may be in particle form. The metal salt of an organic phosphinic acid may have an average particle size of about 0.01 to about 10 μm, for example about 0.05 to about 10 μm, and as another example about 1 to about 7 μm. If the particle size of the metal salt of an organic phosphinic acid is more than about 10 μm, impact strength and flame retardancy may be deteriorated, and if the particle size of the metal salt of an organic phosphinic acid is less than about 0.01 μm, extrudability may be deteriorated, which can make it difficult to prepare a molded article.

The metal salt of an organic phosphinic acid may have a phosphorus content of about 10 to about 70% by weight, for example about 15 to about 50% by weight. In exemplary embodiments, the phosphorus content may range from about 12 to about 45% by weight.

In the present invention, the flame retardant polyester resin composition may include the metal salt of an organic phosphinic acid in an amount of about 1 to about 50 parts by weight, for example, about 3 to about 40 parts by weight, and as another example about 5 to about 30 parts by weight, based on about 100 parts by weight of the polyester resin (A). In some embodiments, the metal salt of an organic phosphinic acid may be used in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 parts by weight. Further, according to some embodiments of the present invention, the amount of the metal salt of an organic phosphinic acid can be in a range from about any of the foregoing amounts to about any other of the foregoing amounts. When the metal salt of an organic phosphinic acid is used in an amount of about 50 parts by weight or less, good thermal stability and mechanical properties may be obtained. In exemplary embodiments, the metal salt of an organic phosphinic acid may be used in an amount of about 5 to about 20 parts by weight.

(C) Ionomer Resin

The ionomer resin is a resin in which a small amount of ionic groups are attached to a nonpolar polymer chain. In exemplary embodiments, the ionomer resin may include a copolymer of an α-olefin and an α,β-unsaturated carboxylic acid, a sulfonic acid group-substituted polystyrene, a copolymer of an α-olefin, an α,β-unsaturated carboxylic acid, and a copolymerizable monomer, or a mixture thereof which is neutralized with metal ions having a valence of from 1 to 4. Methods of preparing ionomer resins are well known to persons skilled in the art and ionomer resins suitable for use in the present invention are commercially available.

Examples of the α-olefin may include, but are not limited to, ethylene, propylene, butene, and the like. The α-olefins may be used alone or in combination with one another. In exemplary embodiments, the α-olefin is ethylene.

Examples of the α,β-unsaturated carboxylic acid may include, but are not limited to, acrylic acid, methacylic acid, ethacrylic acid, itaconic acid, maleic acid, and the like. The α,β-unsaturated carboxylic acids may be used alone or in combination with one another. In exemplary embodiments, the α,β-unsaturated carboxylic acid is acrylic acid or methacrylic acid.

Examples of the copolymerizable monomer may include, but are not limited to, acrylic acid ester, methacrylic acid ester, styrene, and the like. The copolymerizable monomers may be used alone or in combination with one another.

Examples of the metal ions having a valence of from 1 to 4 may include, but are not limited to, lithium, sodium, potassium, magnesium, barium, lead, tin, zinc, aluminum, ferrous and ferric ions, and the like, and mixtures thereof. In exemplary embodiments, the metal ions include lithium, sodium, potassium, or zinc.

The ionomer resin may have an acid content of about 3 to about 25% by weight, for example about 15 to about 25% by weight. As acid content increases, surface hardness and tensile strength increase, whereas impact strength decreases. In exemplary embodiments of the present invention, the acid content may be neutralized with a metal cation. Since an acid moiety can react with an ester bond of polyester, the acid moiety may be neutralized with a metal cation in order to have compatibility with the polyester. In an exemplary embodiment, about 20 to about 80% of the acid content may be substituted with metal ions such as Li⁺, Na⁺, Ca⁺, Zn²⁺, Mg²⁺, K⁺ and mixtures thereof. In exemplary embodiments, the ionomer is neutralized with potassium, since it has a characteristic of absorbing water which is harmful to the polyester.

In exemplary embodiments of the invention, the ionomer resin may be an α,β-ethylenically unsaturated C₃ to C₈ carboxylic acid-ethylene copolymer having an acid content of about 3 to about 25% by weight, in which about 20 to about 80% of the acid content is substituted with metal ions such as Li⁺, Na⁺, Zn²⁺, Mg²⁺, K⁺ and mixtures thereof.

The flame retardant polyester resin composition may include the ionomer resin in an amount of about 0.01 to 20 parts by weight, for example about 0.1 to about 10 parts by weight, as another example about 0.1 to 5 parts by weight, and as another example about 0.1 to 3 parts by weight, based on about 100 parts by weight of the polyester resin (A). In some embodiments, the ionomer resin may be used in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20 parts by weight. Further, according to some embodiments of the present invention, the amount of the ionomer resin can be in a range from about any of the foregoing amounts to about any other of the foregoing amounts. If the amount of the ionomer resin is more than about 20 parts by weight, flowability and rigidity may be deteriorated.

(D) Filler

In the present invention, fillers in various forms can be used for improving mechanical properties, heat resistance, and dimensional stability of the composition.

The fillers may include organic fillers, inorganic fillers, and combinations thereof. Examples of the fillers suitable for use in the present invention may include, but are not limited to, carbon fibers, glass fibers, glass beads, glass flakes, carbon blacks, clay, kaolin, talc, mica, calcium carbonate, and the like. These fillers may be used alone or in combination with one another. The fillers may be in various forms such as, but not limited to, particle forms, bead forms, fiber forms, and the like, and mixtures thereof. In exemplary embodiments, the filler is glass fiber.

The flame retardant polyester resin composition may include filler in an amount of about 1 to about 100 parts by weight based on about 100 parts by weight of the polyester resin (A). In an exemplary embodiment, the filler may be used in an amount of about 10 to about 50 parts by weight, based on about 100 parts by weight of the polyester resin (A). In another exemplary embodiment, the filler may be used in an amount of about 50 to about 95 parts by weight, based on about 100 parts by weight of the polyester resin (A). In other exemplary embodiment, the filler may be used in an amount of about 30 to about 75 parts by weight, based on about 100 parts by weight of the polyester resin (A). In some embodiments, the filler may be used in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 parts by weight. Further, according to some embodiments of the present invention, the amount of the filler can be in a range from about any of the foregoing amounts to about any other of the foregoing amounts.

The flame retardant polyester resin of the present invention may further comprise, depending its usage, at least one or more additives selected from heat stabilizers, antioxidants, compatibilizers, light stabilizers, releasing agents, lubricants, pigments, dyes, inorganic fillers, flame retardants, flame retardant aids, nucleating agents, impact modifiers, coupling agents, antistatic agents, and dispersants. These additives may be used alone or in combination with one another. In exemplary embodiments, the additive may be used in an amount of about 30 parts by weight or less, based on about 100 parts by weight of the polyester resin. In some embodiments, the additive may be used in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the additive can be in a range from about any of the foregoing amounts to about any other of the foregoing amounts.

The flame retardant polyester resin composition according to the present invention can be prepared by conventional methods. For example, all the components and additives can be mixed together and extruded through an extruder and can be prepared in the form of pellets.

The present invention provides a molded article molded from the resin composition. In an exemplary embodiment, the molded article may have a flame retardancy of 5V at a sample thickness of 2.0 mm according to UL-94 5V Test and a vicat softening temperature of about 220° C. or higher at a sample thickness of ¼″ under a load of 18.5 kg/cm² according to ASTM D648. In another exemplary embodiment, the molded article may have a vicat softening temperature of about 220 to 300° C. at a sample thickness of ¼″ under a load of 18.5 kg/cm² according to ASTM D648.

In exemplary embodiments, the molded article may have an impact strength of about 5.0 to about 15.0 kgf·cm/cm at a sample thickness of ⅛″ according to ASTM D256 at room temperature, a tensile strength of about 900 to about 1500 kgf·cm/cm at a sample thickness of ⅛″ according to ASTM D638, and a flexural strength of about 1250 to about 2000 kgf·cm/cm at a sample thickness of ¼″ according to ASTM D790.

The composition of the present invention can be molded into various articles since it can have excellent flame retardancy, heat resistance, and impact resistance. The resin composition of the invention can be particularly suitable for the housings of electric/electronic appliances including housing of office equipment such as computers, copiers, facsimiles, printers, and the like, in addition to structural materials.

The invention may be better understood by reference to the following examples which are intended for the purpose of illustration and are not to be construed as in any way limiting the scope of the present invention, which is defined in the claims appended hereto.

### EXAMPLES

### (A) Polyester Resin

(A1) Polyester resin having an intrinsic viscosity of 0.8 dL/g and a melting point of 255° C. manufactured by Saehan Company (product name: ESLON PET H-2211) is used.

(A2) PET having an intrinsic viscosity of 0.8 dL/g and a melting point of 254° C. manufactured by SK Chemical Co., Ltd. (product name: BB-8055) is used.

(A3) PET having an intrinsic viscosity of 0.84 dL/g and a plasticizer added thereto manufactured by SK Chemical Co., Ltd. (product name: BL-8450) is used.

### (B) Metal Salt of an Organic Phosphinic Acid

Aluminum salt of diethyl phosphinic acid having an average particle size of 5 μm and phosphorus content of 23% by weight manufactured by Clariant GmbH of Germany (product name: Exolit 930) is used.

### (C) Ionomer Resin

The ionomer resin manufactured by DuPont (product name: Surlyn 8945) in which the metal ion is Na⁺ and which has a melt index of 4.0 g/10 min according to ASTM D 1238 condition E is used.

### (D) Filler

Glass fiber having a diameter of 10 μm (product name: VETROTEX 952) is used.

### Examples 1-5

The components as shown in Table 1 are mixed, and the mixture is extruded through a conventional twin screw extruder at a temperature range of 250-280° C. to prepare a product in pellet form. The pellets are dried at 100° C. for 4 hours and then molded into test specimens for physical properties and flame retardancy using a 6 oz injection molding machine at 250-280° C. with a mold temperature of 50-100° C. The physical properties of the test specimens are measured as follow and the results are shown in Table 1 below.

(1) Flame retardancy: The flame retardancy is measured in accordance with UL-94 5V Test using 2.0 mm thick test specimens.

(2) Heat resistance: The heat resistance is measured in accordance with ASTM D648 under a load of 18.5 kg/cm² at a sample thickness of ¼″.

(3) Impact strength: The impact strength is measured in accordance with ASTM D-256 using ⅛″ thick test specimens at room temperature.

(4) Tensile strength: The tensile strength is measured in accordance with ASTM D-638 using ⅛″ thick test specimens at room temperature.

(5) Flexural strength: The flexural strength is measured in accordance with ASTM D-790 using ¼″ thick test specimens at room temperature.

TABLE 1

| | | Examples | | | | |
|---|---|---|---|---|---|---|
| Composition | | 1 | 2 | 3 | 4 | 5 |
| (A) Polyethylene | (A1) | 100 | 100 | 100 | 100 | — |
| Terephthalate | (A2) | — | — | — | — | 100 |

| | | | | | |
|---|---|---|---|---|---|
| (B) Metal salt of an | 8 | 10 | 12 | 12 | 10 |
| organic phosphinic acid | | | | | |
| (C) Ionomer resin | 1.0 | 0.3 | 0.5 | 1.0 | 0.5 |
| (D) Filler | 47 | 49 | 49 | 49 | 49 |
| Flame retardancy | 5 V | 5 V | 5 V | 5 V | 5 V |
| Heat resistance (° C.) | 230 | 222 | 235 | 231 | 226 |
| Impact strength | 5.7 | 6.4 | 6.1 | 5.4 | 5.7 |
| (⅛″ kgf · cm/cm) | | | | | |
| Tensile strength | 1084 | 1106 | 1016 | 927 | 1086 |
| (⅛″ kgf · cm/cm) | | | | | |
| Flexural strength | 1442 | 1576 | 1427 | 1372 | 1278 |
| (¼″ kgf · cm/cm) | | | | | |

### Comparative Examples 1-4

Comparative Examples 1-4 are prepared in the same manner as in Examples 1-5 except the ionomer resin is not added. The results of the physical properties and input amount of components in the Comparative Examples are shown in Table 2.

TABLE 2

| | | Comparative Examples | | | |
|---|---|---|---|---|---|
| Composition | | 1 | 2 | 3 | 4 |
| (A) Polyethylene | (A2) | 100 | 100 | — | — |
| Terephthalate | (A3) | — | — | 100 | 100 |

| | | | | |
|---|---|---|---|---|
| (B) Metal salt of an organic | 8 | 10 | 8 | 10 |
| phosphinic acid | | | | |
| (C) Ionomer resin | — | — | — | — |
| (D) Filler | 47 | 49 | 47 | 49 |
| Flame retardancy | Fail | Fail | Fail | Fail |
| Heat resistance (° C.) | 210 | 220 | 209 | 213 |
| Impact strength (⅛″ kgf · cm/cm) | 6.6 | 5.9 | 6.7 | 6.8 |
| Tensile strength (⅛″ kgf · cm/cm) | 1044 | 1035 | 1166 | 1101 |
| Flexural strength (¼″ kgf · cm/cm) | 1337 | 1302 | 1235 | 1348 |

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A flame retardant polyester resin composition having excellent heat resistance comprising:
(A) about 100 parts by weight of a polyester resin;
(B) about 1 to about 50 parts by weight of a metal salt of an organic phosphinic acid;
(C) about 0.01 to about 20 parts by weight of an ionomer resin; and
(D) about 1 to about 100 parts by weight of a filler, wherein the amount of (B), (C) and (D) is based on about 100 parts by weight of the polyester resin (A).

2. The flame retardant polyester resin composition of claim 1, wherein said polyester resin (A) comprises polyethylene terephthalate, polybutylene terephthalate or a mixture thereof.

3. The flame retardant polyester resin composition of claim 1, wherein said metal salt of an organic phosphinic acid (B) has an average, particle size of about 0.05 to about 10 μm.

4. The flame retardant polyester resin composition of claim 1, wherein said metal salt of an organic phosphinic acid (B) is represented by the following Chemical Formula 1: 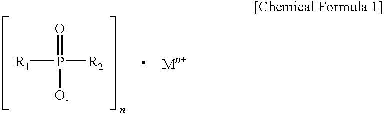
wherein R₁ and R₂ independently comprise C₁-C₆ alkyl, C₃-C₆ cyclic alkyl or C₆-C₁₀ aryl; M is Al, Zn, Mg, K or Ca; and n is an integer of 1 or 3.

5. The flame retardant polyester resin composition of claim 1, wherein said metal salt of an organic phosphinic acid (B) has a phosphorus content of about 10 to about 70% by weight.

6. The flame retardant polyester resin composition of claim 1, wherein said ionomer resin (C) comprises a copolymer of an α-olefin and an α,β-unsaturated carboxylic acid, a sulfonic acid group-substituted polystyrene, a copolymer of an α-olefin, an α,β-unsaturated carboxylic acid, and a copolymerizable monomer, or a mixture thereof which is neutralized with metal ions having a valence of from 1 to 4.

7. The flame retardant polyester resin composition of claim 6, wherein said α-olefin comprises ethylene, propylene, butene, or a mixture thereof; said α,β-unsaturated carboxylic acid comprises acrylic acid, methacylic acid, ethacrylic acid, itaconic acid, maleic acid, or a mixture thereof; said copolymerizable monomer comprises acrylic acid ester, methacrylic acid ester, styrene, or a mixture thereof; and said metal ion having a valence of from 1 to 4 comprises lithium, sodium, potassium, magnesium, barium, lead, tin, zinc, aluminum, ferrous iron, ferric ion, or a mixture thereof.

8. The flame retardant polyester resin composition of claim 1, wherein said ionomer resin (C) has an acid content of about 3 to about 25% by weight.

9. The flame retardant polyester resin composition of claim 1, wherein said filler (D) comprises carbon fiber, glass fiber, glass bead, glass flake, carbon black, clay, kaolin, talc, mica, calcium carbonate, or a mixture thereof.

10. The flame retardant polyester resin composition of claim 1, wherein said resin composition further comprises at least one additive selected from the group consisting of heat stabilizers, antioxidants, compatibilizers, light stabilizers, releasing agents, lubricants, pigments, dyes, inorganic fillers, flame retardants, flame retardant aids, nucleating agents, impact modifiers, coupling agents, antistatic agents, dispersants and mixtures thereof.

11. A molded article molded from the resin composition as defined in claim 1.

12. The molded article of claim 11, wherein said molded article has a flame retardancy of 5V at a sample thickness of 2.0 mm according to UL-94 5V Test and a vicat softening temperature of about 220° C. or higher at a sample thickness of ¼″ under a load of 18.5 kg/cm² according to ASTM D648.
